(19) United States
(12) Patent Application Publication
(10) Pub. No.: US 2022/0034298 A1
(43) Pub. Date: Feb. 3, 2022

(54) WIND TURBINE BLADE WITH MULTIPLE INNER BLADE PROFILES

(71) Applicant: Vestas Wind Systems A/S, Aarhus N. (DK)

(72) Inventors: Peter Bjørn ANDERSEN, Skanderborg (DK); Thomas S. Bjertrup NIELSEN, Randers Sv (DK)

(21) Appl. No.: 17/275,312

(22) PCT Filed: Sep. 13, 2019
(86) PCT No.: PCT/DK2019/050269

§ 371 Date: Mar. 11, 2021

(30) Foreign Application Priority Data
Sep. 13, 2018 (DK) PA 2018 70587

(51) Int. Cl. F03D 7/02; F03D 1/06

(52) U.S. Cl. CPC F03D 7/0236; F05B 2260/70; F03D 1/0641

(57) ABSTRACT

A wind turbine blade (6) having a span-wise direction between an inner tip region (6a) and an outer tip region (6b), and a chord-wise direction (AA) perpendicular to the span-wise direction is disclosed. The wind turbine blade (6) comprises a hinge (7), an outer blade part (8) and an inner blade part (9). The hinge (7) is arranged to connect the wind turbine blade (6) to a blade carrying structure (5) of a wind turbine (1). The hinge (7) is arranged at a distance from the inner tip region (6a) and at a distance from the outer tip region (6b). The outer blade part (8) is arranged between the hinge (7) and the outer tip region (6b) and the inner blade part (9) is arranged between the hinge (7) and the inner tip region (6a). The inner blade part (9) comprises at least two inner blade portions (20) each having a profile and wherein the inner blade portions (20) are arranged such that the profiles are spaced from each other in the chord-wise direction (AA).

### FIELD OF THE INVENTION

The present invention relates to a wind turbine blade comprising an inner blade part and an outer blade part connected pivotally to a blade carrying structure of a wind turbine via a hinge. The wind turbine blade of the present invention has a reduced mass and provides improved aerodynamic performance compared to classical modern MW designs.

### BACKGROUND OF THE INVENTION

Wind turbines are typically provided with wind turbine blades normally designed to be in one piece extending radially from a rotor of the wind turbine and which are designed to have an airfoil type shape. This shape provides optimized lift and drag forces acting on the blades which then lead to an optimized utilization of wind resources. Furthermore, these wind turbine blades may be pitch controlled, i.e., the angle of attack of the wind turbine blade relative to the incoming wind is adjusted by rotating the wind turbine blade about a longitudinal axis. Mounting the wind turbine blade to a hub of a wind turbine and interfacing the blade to a blade pitch mechanism requires a massive inner blade portion with a cylindrical cross-section. This massive cylinder normally does not contribute to the energy conversion efficiency as it reduces aerodynamic performance of the wind turbine blade. The increased mass results in high loads on the wind turbine blades, the pitch mechanism and on other parts of the wind turbine, such as drivetrain, hub, tower, etc. Furthermore, a heavy blade is difficult to handle, especially during manufacturing, transporting and mounting.

Alternatively, wind turbines may be provided with wind turbine blades which are connected to a blade carrying structure via hinges, thereby allowing a pivot angle defined between the wind turbine blades and the blade carrying structure to be varied. In such wind turbines the diameter of the rotor of the wind turbine, and thereby the area swept by the rotor, is varied when the pivot angle is varied.

U.S. Pat. No. 4,632,637 discloses a high speed, downwind horizontal axis wind turbine having three circumferentially spaced lightweight blades having inner support arms radially outwardly disposed blade segments which are pivotally connected to the support arms, so as to fold straight downwind under high wind conditions or high rotating speeds.

### DESCRIPTION OF THE INVENTION

It is an object of embodiments of the invention to provide a hinged wind turbine blade with an increased aerodynamic performance, in particular at low wind speeds, compared to prior art hinged wind turbine blades.

It is a further object of embodiments of the invention to provide a hinged wind turbine blade with a reduced mass compared to prior art hinged wind turbine blades.

It is an even further object of embodiments of the invention to provide a wind turbine blade which decreases loads on the wind turbine.

According to a first aspect the invention provides a wind turbine blade having a span-wise direction between an inner tip region and an outer tip region, a chord-wise direction perpendicular to the span-wise direction and a thickness direction, the wind turbine blade comprising:
a hinge arranged to connect the wind turbine blade to a blade carrying structure of a wind turbine, the hinge being arranged at a distance from the inner tip region and at a distance from the outer tip region,
an outer blade part arranged between the hinge and the outer tip region, and
an inner blade part arranged between the hinge and the inner tip region,
   wherein the inner blade part comprises at least two inner blade portions each having a profile, the inner blade portions being arranged such that the profiles are spaced from each other in the chord-wise and/or thickness direction.

Thus, according to the first aspect, the invention provides a wind turbine blade. The wind turbine blade has a span-wise direction, a chord-wise direction, and a thickness direction. The span-wise direction is defined along the length of the wind turbine blade, i.e., it extends between an inner tip region and an outer tip region of the wind turbine blade. In the present context the term “inner tip region” should be interpreted to mean a region of the wind turbine blade in which one or more extremities of the wind turbine blade are positioned, and which is arranged closest to a hub of the wind turbine. Similarly, the term “outer tip region” should be interpreted to mean a region of the wind turbine blade in which one or more extremities of the wind turbine blade are positioned, and which is arranged furthest away from the hub.

The chord-wise direction is perpendicular to the span-wise direction, i.e., the chord-wise direction is defined along the chord of the wind turbine blade. The chord is defined as the line interconnecting the leading edge and the trailing edge of the wind turbine blade.

The thickness direction is measured perpendicularly to the chord-wise direction between a pressure surface and a suction surface of the blade, in a given cross-section perpendicular to the blade span-wise direction. The blade may twist along its length so the chord-wise direction and the thickness direction can change along the blade's length.

The wind turbine blade comprises a hinge being arranged to connect the wind turbine blade to a blade carrying structure of a wind turbine. The hinge enables the wind turbine blade to perform pivot movements relative to the blade carrying structure between a minimum pivot angle and a maximum pivot angle. The hinge may be or comprise a bearing, e.g. in the form of a journal bearing, a roller bearing, or any other suitable kind of bearing.

The blade carrying structure of the wind turbine is connected to the hub of the wind turbine and may carry one or more wind turbine blades of the wind turbine. The hub is mounted rotatably on a nacelle of the wind turbine. The nacelle is typically mounted on top of a wind turbine tower. In this case the wind turbine may comprise only one nacelle carrying only one hub and one rotor. Such wind turbines are sometime referred to as single rotor wind turbines. As an alternative, the wind turbine may comprise two or more nacelles, each carrying one or more hubs and one or more rotors. Such wind turbines are sometimes referred to as multirotor wind turbines.

As the hub is rotatably mounted to a nacelle, one or more wind turbine blades then rotate along with the hub and the blade carrying structure relative to the nacelle.

The hinge is arranged at a distance from the inner tip region and at a distance from the outer tip region. Thereby the wind turbine blade is hinged to the blade carrying structure at a position which is not at an end of the wind turbine blade. This allows the tip regions of the wind turbine blade to be designed without taking into consideration that an end of the wind turbine blade needs to be mounted on a pitch mechanism.

The wind turbine blade defines an outer blade part and an inner blade part. The outer blade part is arranged between the hinge and the outer tip region, and is therefore arranged further away from the hub and the blade carrying structure than the inner blade part. The outer blade part may have an airfoil profile and may represent a major contributor to a power production efficiency of the wind turbine.

The inner blade part is arranged between the hinge and the inner tip region and is therefore arranged closer to the hub and the blade carrying structure than the outer blade part. The inner blade part may form an overlapping region with the blade carrying structure when the blade is arranged in a position defining a minimum pivot angle. Typically, the inner blade part is shorter than the outer blade part.

Therefore the inner blade part does not form a root end of the blade, as is the case in traditional wind turbine blades. A configuration with a hinge arranged at a distance from the inner tip region and at a distance from the outer tip region allows for designing both the inner blade part and the outer blade part in order to achieve better aerodynamic properties, and/or in order to fulfil other design objectives, such as low mass, low loads, etc.

According to the invention, the inner blade part comprises at least two inner blade portions, each having a profile. The inner blade portions are all merged or joined at or near the hinge. The profiles of the inner blade portions may have any suitable cross-section. This will be described in further detail below. The inner blade portions are arranged such that the profiles are spaced from each other in the chord-wise direction and/or thickness direction. Spacing between two profiles may be the same for all the profiles or it may be different. Furthermore, spacing between two profiles may vary from the hinge and towards the inner tip region as the cross-section of the inner blade portions may change over their length, or the orientations of the inner blade portions may be non-parallel.

When the wind turbine blade is mounted on the blade carrying structure, the inner blade portions are arranged at a distance from the blade carrying structure. This distance may increase as the blade pivots.

The wind turbine blade with inner blade portions enables various designs of the blade. Various cross-sections of the inner blade portions can define more optimal aerodynamic profiles which contribute to extracting more energy from the wind. At low wind speeds, the wind turbine blade, and in particular the inner blade portion, is closest to the blade carrying structure creating a high lift acting on close proximity to the blade carrying structure. The high lift is created as the flow is guided by the inner blade portions. In principle, the greater the number of inner blade portions, the better guidance of the flow is provided, and therefore the lift is increased. At high wind speeds, the wind turbine blade pivots and the inner blade part is further away from the blade carrying structure and therefore the inner blade portions only influence the lift coefficient acting on the blade carrying structure insignificantly. Thus, the wind turbine blade can be designed in a manner which optimizes the aerodynamic performance of the wind turbine blade along the entire length of the wind turbine blade.

The blade carrying structure may be in the form of an arm with a circular cross-section. A simple structure with a circular cross-section will not generate lift, and it will just generate drag. However, according to the invention, by arranging the inner blade portions adjacent to the blade carrying structure, the blade carrying structure will generate lift and will thus contribute to the power production of the wind turbine. In effect, a slot is created between the inner blade portions and the blade carrying structure through which there is air flow with increased speed (compared to free stream airflow), which will result in the blade carrying structure generating lift.

By having spacing between the inner blade portions the total mass of the inner blade part is significantly reduced as the inner blade part is partitioned and a large portion of material which would normally form part of the blade is omitted. Having lighter wind turbine blades would enable development of a new generation high efficiency wind turbines with lighter rotors. The lower mass of the wind turbine blade decreases the loads on the wind turbine blade itself, as well as on other parts of the wind turbine, in particular the hub, the drivetrain and the tower. This allows these parts of the wind turbine to be designed for handling lower loads, and this will result in lower mass and lower manufacturing costs for these parts, and thereby in lower total manufacturing costs for the wind turbine. A reduction in mass of the wind turbine blade may be in the order of 10-15% of the wind turbine blade mass.

Furthermore, when the blade is lighter, its transportation is easier, i.e., special means of transportation due to large weight of the wind turbine blade is not required.

Lighter blades with reduced amount of material used for their production, and easier transportation lead to a considerable cost reduction.

Finally, the inner blade portions contribute to the overall lift coefficient of wind turbine blade which is increased compared to a wind turbine blade with the inner blade part being in one piece. An increase in the lift coefficient results in an increase in power produced by the wind turbine.

The profiles of the inner blade part may have a lift generating profile. To be able to generate lift, the lift generating profile typically comprises a trailing edge and a leading edge, interconnected by a suction side and a pressure side, thereby forming a traditional aerodynamic profile, such as an airfoil. The leading edge may be rounded while the trailing edge may be sharp and the lift generating profile may be oriented within the inner blade part such that they experience a positive angle of attack of the wind. Furthermore, the lift generating profile may define a chord, i.e., the line interconnecting the leading edge and the trailing edge. The length of the chord as well as the orientation of the chord may vary along the span-wise direction of the inner blade part. The pressure side may be facing the blade carrying structure at the minimum pivot angle. All the lift generating profiles may have the same such orientation within the inner blade part. In general, the larger the number of the lift generating profiles is the larger the lift may be as the flow is guided. Providing the inner blade portions with lift generating properties additionally increases the aerodynamic properties of the wind turbine blade, thereby contributing to improved efficiency of the wind turbine as more energy is extracted from the wind.

Alternatively, other profiles than lift generating ones may be used for the profiles of the inner blade part, e.g., a simple flat profile, e.g. formed by pultrusion with any cross section. Furthermore, the profiles may not necessarily comprise a leading edge and a trailing edge and may have a constant chord along their length.

The inner blade part and the outer blade part may be two separate parts being joined to each other. According to this embodiment, the wind turbine blade is segmented in the sense that it is each made from separate parts which are joined to each other to form the wind turbine blade. The outer blade part and the inner blade part may therefore be manufactured separately. This is drastically simpler than manufacturing the wind turbine blade in one piece as it typically requires larger moulds for moulding the blade. Furthermore, when the blade portions are manufactured as separate pieces, their transportation is easier and they can be assembled at a site of the wind turbine, i.e., there is no need for transporting the wind turbine blade in one piece, which may require special means of transportation due to large size and large weight of the wind turbine blade. Providing the inner blade part and the outer blade part as two separate parts allows for assembling the wind turbine blade at the site.

Additionally, the inner blade portions may as well be separate parts. In this case each of the inner blade portions is separately joined to the outer blade part during assembly of the wind turbine blade. Each of the inner blade portions may be more robust compared to the inner blade part formed in one piece as these smaller portions may have an improved stability and stiffness. During operation of the wind turbine, the wind turbine blade is exposed to significant loads resulting from the wind acting on the wind turbine blade. These loads may cause the wind turbine blade to deflect. These deflections reduce clearance between the inner blade part and the blade carrying structure. However, having a stiffer blade ensures that clearance between the inner blade part and the blade carrying structure is not affected by the blade deflection. Additionally, stiffening of the inner blade part provides a more stable blade resulting in reduced vibrations of the wind turbine blade.

The wind turbine blade may further comprise a hinge part interconnecting the inner blade part and the outer blade part. In the case when the inner blade part and the outer blade part are separate parts the hinge part is interconnecting them. The hinge part can be designed to meet requirements at the hinge, e.g. with respect to strength and material thickness, without having to consider other requirements which may be relevant for other parts of the wind turbine blade, e.g. with respect to weight, aerodynamic properties, flexibility, etc. The inner blade part and the outer blade part may be joined to each other by the hinge part in a region at or near the hinge. The hinge part may be connected with the hinge ensuring the connection of the wind turbine blade with the blade carrying structure. The hinge part may comprise one or more individual parts which work together enabling interconnection between the inner blade part and the outer blade part. All the hinge parts may, together with the hinge, enable the pivot movements of the wind turbine blade. As mentioned above, the inner blade part may comprise separate inner blade portions. In this case, the hinge part may comprise separate mounting interfaces allowing each of the inner blade portions to be mounted on the hinge part and thereby interconnecting it with the outer blade part. These separate mounting interfaces may be in the form of or comprise separate slots, bolts connections, or similar. The hinge part may comprise a plurality of bolts for interconnecting the inner blade part and the outer blade part.

As an alternative, the inner blade part and the outer blade part may form one piece. In this case, manufacturing of the one piece wind turbine blade is performed by using one-piece mould. The inner blade part and the outer blade part may still be clearly distinguishable, each having its own function. Having the wind turbine blade forming one piece eases requirements on maintenance as there are no additional parts requiring additional care.

The wind turbine blade may be configured to have a biasing mechanism attached thereto, the biasing mechanism being arranged to apply a biasing force to the wind turbine blade which biases the wind turbine blade towards a position defining a minimum pivot angle. According to this embodiment, the wind turbine blade performs the pivot movements relative to the blade carrying structure between a minimum pivot angle and a maximum pivot angle wherein the pivot movements towards a position defining the maximum pivot angle are performed against the applied biasing force.

The biasing force could, e.g., be applied by means of wires attached to an inner blade part of the wind turbine blade, which pull the wind turbine blade outwards, i.e. towards the minimum pivot angle. The wires may be attached to each of the inner blade portions separately. Alternatively, the inner blade portions may be joined together, e.g. by a winglet, and then one end of the wire may be attached to the winglet and another one may be attached to a mechanism for operating the wire(s) in order to provide the biasing force.

As an alternative, the biasing force could be applied by means of one or more springs acting in the wind turbine blade, e.g. compressible springs arranged for pulling or pushing the wind turbine blade towards the minimum pivot angle.

As another alternative, the biasing force could be in the form of a moment. In this case the biasing force could be applied by means of a torsional spring arranged in the hinge which pulls or pushes the wind turbine blade towards the minimum pivot angle.

As another alternative, the biasing force could be applied by means of hydraulic mechanisms connected to the wind turbine blade and being arranged for pulling or pushing the wind turbine blade towards the minimum pivot angle.

The biasing mechanism may be attached to the wind turbine blade by means of a suitable connecting interface, e.g. including a hook, an eyelet or the like.

In one embodiment of the invention, the inner blade portions may be joined at the inner tip region. Joining the inner blade portions at the inner tip region improves the stability and rigidity of the inner blade portion and therefore the wind turbine blade as a whole. Furthermore, the joint may have a special form which improves aerodynamic properties of the wind turbine. In one example, the joint may be in the form of a winglet. In another example, the blade portions may be joined by means of any suitable kind of element which provides interconnects the blade portions and provide a required stiffness and/or structural stability, such as a simple profile having cylindrical, rectangular or triangular cross-section. In the case that the wind turbine blade is configured to have a biasing mechanism attached thereto, as described above, such an interconnecting element may form a suitable position for attaching the biasing mechanism, since it is structurally strong, and because a common biasing force can thereby be applied simultaneously to all of the inner blade portions. This is in particular relevant in the case that the biasing mechanism comprises wires arranged to pull the wind turbine blade towards the position defining minimum pivot angle.

At least one of the inner blade portions may be provided with a balancing mass. The balancing mass may be positioned anywhere along the inner blade portions, such as near the region close to the hinge, such as near the inner tip region, or there between. The balancing mass may separately be provided on each of the inner blade portions. Alternatively, the balancing mass may be provided in one piece holding all the inner blade portions together, as described above. Applying a balancing mass in this manner moves a centre of mass of the wind turbine blade at rest in a direction towards the inner tip end, as compared to an identical wind turbine blade without the balancing mass. Thereby, by selecting and positioning the balancing mass in an appropriate manner, the position of the centre of mass for the wind turbine blade at rest can be positioned at any desired position. For instance, the wind turbine blade may have the centre of mass for the wind turbine blade at rest which may be positioned between the hinge and the inner tip region of the wind turbine blade. The centre of mass for the wind turbine blade may be arranged in a part of the wind turbine blade which is arranged closer to the hub than the hinge. Placing the balancing mass at the inner tip region may move the centre of mass to be at that inner tip region.

During operation of the wind turbine, the wind turbine blade rotates such that a centrifugal force acts on the wind turbine blade, at the position of the centre of mass. Thereby the centrifugal force will tend to push the part of the wind turbine blade arranged between the hinge and the inner tip region, i.e. the part of the wind turbine blade where the centre of mass is arranged, in an outwards direction. This will cause the wind turbine blade to pivot via the hinge in such a manner that the wind turbine blade is rotated towards a position where the span-wise direction of the wind turbine blade is arranged substantially parallel to the rotational axis of the hub. Furthermore, by placing the balancing mass at the inner blade portions close to the inner tip region and therefore having the centre of mass in the part of the wind turbine blade arranged closer to the hub than the hinge improves the lift on the wind turbine blade.

At least one of the inner blade portions may be provided with a winglet. One winglet may be provided joining all the inner blade portions of the inner blade part and increasing a structural strength of the inner blade part. In this case the winglet forms the interconnecting part described above. The winglet may have a width which exceeds the chord of the inner blade part. Having the inner blade portions provided with one or more winglets improves the efficiency of the wind turbine blade by reducing drag. The winglet provided on one or more inner blade portions may have precisely selected weight thereby acting as a balancing mass which moves a centre of mass of the wind turbine blade at rest in a direction towards the inner tip portion, as described above. The winglet provided on one or more inner blade portions may be attached to a wire being a part of the biasing mechanism pull the wind turbine blade towards a position defining minimum pivot angle. These features may also be combined such that one or more winglets provided on the inner blade portions may at the same time have a role of the balancing mass and/or be connected with wires being part of a biasing mechanism. Furthermore, one winglet may be provided as a joint for the inner blade potions. This single winglet may have a selected mass influencing the centre of mass of the wind turbine blade further improving the efficiency of the wind turbine blade and/or it can be attached to wires being part of the biasing mechanism, as described above. It should be noted that any kind of joint joining the inner blade portions may be a balancing mass and may be attached to the wires of the biasing mechanism.

According to one embodiment of the present invention, the profiles of the inner blade portions may be different from each other. The profiles may have different cross-section, and/or different chord, and/or different thickness. According to this embodiment, the overall profile of the inner blade part may be an aerodynamic profile composed of different inner blade portions. For instance, the outermost blade portions may be in the form of airfoils while the rest of the inner blade portions between the outermost portions may have a rectangular cross-section. Alternatively, only one of the outermost blade portions may be in the form of an airfoil while the rest of the blade portions may have any other cross-section. Designing the inner blade portions with a number of parameters which may be varied (chord, thickness, cross-section, etc.) results in an inner blade part with improved aerodynamic properties and gives an opportunity for designing the inner blade part with an optimal mass and aerodynamic properties.

The inner blade portions may have different length. The lengths of the inner blade portions may further contribute to optimization of the inner blade part and to even better aerodynamic properties of the inner blade part and therefore of the entire wind turbine blade. In one example, the length of the outermost inner blade portions may be the shortest while a portion in the middle of the inner blade portion may be the longest among all the inner blade portions. Reducing the length of some of the inner blade portions leads to an additional mass reduction of the wind turbine blade.

Alternatively, the profiles of the inner blade portions may be identical. In one example, all the profiles of the inner blade portion may be in the form of airfoils with identical chord, thickness and length. Having identical profiles of the inner blade portions may ease manufacturing process as all the same parameters during the process are applied to all the inner blade portions.

According to a second aspect the invention provides a wind turbine comprising a tower, a nacelle mounted on the tower via a yaw system, a hub mounted rotatably on the nacelle, the hub comprising a blade carrying structure, and a wind turbine blade according to the first aspect of the invention, the wind turbine blade being connected to the blade carrying structure via a hinge at a hinge position of the wind turbine blade, the wind turbine blade thereby being arranged to perform pivot movements relative to the blade carrying structure between a minimum pivot angle and a maximum pivot angle.

Thus, according to the second aspect, the invention provides the wind turbine comprising a tower with at least one nacelle mounted on the tower via a yaw system and having one or more wind turbine blades as described above with reference to the first aspect of the invention. The remarks set forth above are therefore equally applicable here.

The wind turbine may comprise only one nacelle, in which case the wind turbine is of a single rotor type. In this case the nacelle will typically be mounted on top of the tower. Alternatively, the wind turbine may comprise two or more nacelles, in which case the wind turbine is of a multirotor type. In this case at least some of the nacelles may be mounted directly on the tower and/or at least some of the nacelles may be mounted on the tower via load carrying structures, e.g. comprising arms extending in a direction away from the centre axis of the tower. Each nacelle may be mounted on the tower via a separate yaw system, or two or more nacelles may be mounted on the tower via a common yaw system, in which case these nacelles are yawed together relative to the tower.

In any event, since the nacelle is mounted on the tower via a yaw system, it can rotate about a substantially vertical rotational axis, relative to the tower, in order to direct one or more rotors of the wind turbine into the incoming wind. The yaw system may be an active yaw system in which the nacelle is rotated actively by means of a yaw drive mechanism, e.g. on the basis of measurements of the wind direction. As an alternative, the yaw system may be a passive yaw system in which the nacelle automatically rotates according to the wind direction without the use of a yaw drive mechanism.

The nacelle may be a traditional nacelle having an outer wall enclosing an interior of the nacelle, the nacelle housing various components of the wind turbine, such as generator, drive train, etc. As an alternative, the nacelle may simply be a structure which is capable of performing yawing movements relative to the tower. In this case some or all of the components described above may be arranged outside the nacelle, e.g. in an interior part of the tower.

A hub is mounted rotatably on the nacelle. The hub comprises a blade carrying structure having one or more wind turbine blades connected thereto. Accordingly, the wind turbine blades rotate along with the hub and the blade carrying structure relative to the nacelle.

The wind turbine blade connected to the blade carrying structure is in accordance with the first aspect of the invention. Accordingly, each of the wind turbine blades is arranged to perform pivot movements relative to the blade carrying structure, via the hinge. A pivot angle is thereby defined between each wind turbine blade and the blade carrying structure, depending on the position of the hinge and thereby of the wind turbine blade relative to the blade carrying structure.

In one embodiment of the invention, the blade carrying structure may comprise an arm, the wind turbine blade being mounted on the arm, and the arm may be configured to pass between at least two of the inner blade portions of the wind turbine blade being mounted thereon during pivoting movements of the wind turbine blade. The number of arms may be the same to the number of the wind turbine blades. Each wind turbine blade may be mounted on each arm in such a way that there is clearance between the inner blade portions which allows the arm to pass through. Such an arrangement allows for versatile ways of mounting the wind turbine blade on the arm. Furthermore, pivot angles larger than 90° are thereby allowed.

The wind turbine may further comprise a biasing mechanism arranged to apply a biasing force to the wind turbine blade which biases the wind turbine blade towards a position defining a minimum pivot angle. This has already been described above with reference to the first aspect of the invention.

The inner blade portions may be arranged at a distance from the blade carrying structure, and the distance may change as the wind turbine blade performs pivot movements. This distance enables the inner blade portions to pass the blade carrying structure as the wind turbine blades rotate along with the hub. Further, at low wind speeds when the wind turbine blade is typically arranged in a position defining a minimum pivot angle, the distance between the inner blade part and the blade carrying structure may be smaller than in the case when the wind turbine blade is pivoted what typically happens at high wind speeds. When the inner blade part is close to the blade carrying structure the lift coefficient provided by the interaction between the blade carrying structure and the inner blade portions is increased, and therefore the aerodynamic properties of the blade carrying structure are improved by the inner blade part having multiple inner blade portions. When the blade is pivoted towards larger pivot angles, the inner blade portions do not influence the aerodynamic properties of the blade carrying structure to the same extent as they are further away from the blade carrying structure.

### BRIEF DESCRIPTION OF THE DRAWINGS

The invention will now be described in further detail with reference to the accompanying drawings in which

FIG. 1 is a side view of a wind turbine according to an embodiment of the invention,

FIGS. 2a-2i show cross-sectional views of a blade carrying structure arm and inner blade part of a wind turbine blade according to nine different embodiments of the invention,

FIGS. 3a-3c show a part of a wind turbine blade according to three different embodiments of the invention,

FIG. 4 shows an exploded view of a part of a blade carrying structure for a wind turbine according to an embodiment of the invention,

FIGS. 5a-5c show cross-sectional views of a blade carrying structure arm and inner blade part of a wind turbine blade according to an embodiment of the invention with the wind turbine blade at three different pivot angles, and

FIG. 6 is a graph showing a lift coefficient as a function of angle of attack in the three situations shown in FIGS. 5a-5c.

### DETAILED DESCRIPTION OF THE DRAWINGS

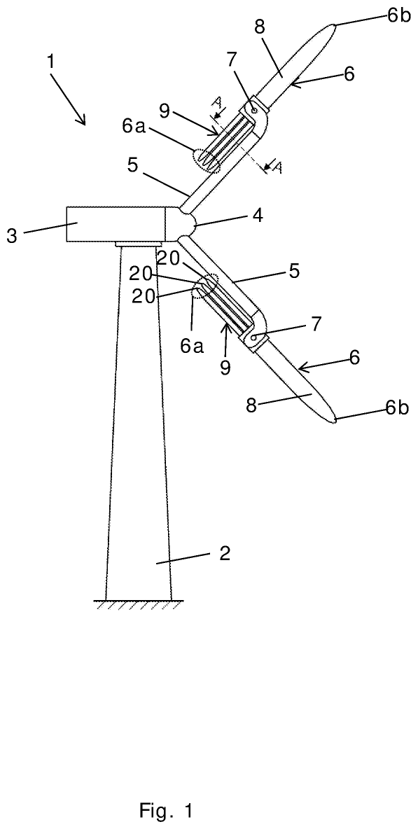

FIG. 1 is a side view of a wind turbine 1 according to an embodiment of the invention. The wind turbine 1 comprises a tower 2 and a nacelle 3 mounted on the tower 2. A hub 4 is mounted rotatably on the nacelle 3, the hub 4 comprising a blade carrying structure 5 with three arms (two of which are visible). A wind turbine blade 6 is connected to each of the arms of the blade carrying structure 5 via a hinge 7. Thus, the wind turbine blades 6 rotate along with the hub 4, relative to the nacelle 3, and the wind turbine blades 6 can perform pivoting movements relative to the blade carrying structure 5, via the hinges 7.

Each wind turbine blade 6 has a span-wise direction between an inner tip region 6a and an outer tip region 6b. The hinge 7 is arranged at a distance from the inner tip region 6a as well as at a distance from the outer tip region 6b. An outer blade part 8 is thereby arranged between the hinge 7 and the outer tip region 6b. Similarly, an inner blade part 9 is arranged between the hinge 7 and the inner tip region 6a. The inner blade part 9 comprises a number of inner blade portions 20, three of which are shown. The inner blade portions 20 are spaced from each other in a thickness direction, i.e. in a direction perpendicular to a chord defined by the wind turbine blade 6, and indicated by AA line.

The wind turbine blade 6 with inner blade portions 20 enables various designs of the blade 6. Various cross-sections of the inner blade portions 20 can define more optimal aerodynamic profiles which contribute to extracting more energy from the wind. At low wind speeds, the wind turbine blade 6, and in particular the inner blade part 9, is closest to the blade carrying structure 5 creating a high lift acting on close proximity to the blade carrying structure 5. The high lift is created as the flow is guided by the inner blade portions 20. Thus, the wind turbine blade 6 can be designed in a manner which optimizes the aerodynamic performance of the wind turbine blade 6 along the entire length of the wind turbine blade 6.

By having spacing between the inner blade portions 20 the total mass of the inner blade part 9 is significantly reduced as the inner blade part 9 is partitioned and a large portion of material which would normally form part of the blade 6 is omitted. Having lighter wind turbine blades would enable development of a new generation high efficiency wind turbines with lighter rotors. The lower mass of the wind turbine blade 6 decreases the loads on the wind turbine blade itself, as well as on other parts of the wind turbine 1, in particular the hub 4, the drivetrain and the tower 2. This allows these parts of the wind turbine 1 to be designed for handling lower loads, and this will result in lower mass and lower manufacturing costs for these parts, and thereby in lower total manufacturing costs for the wind turbine 1.

In FIG. 1 the wind turbine blades 6 are in a position defining a minimum pivot angle. In this position the inner blade part 9 is arranged adjacent to the blade carrying structure arm 5 defining a minimum distance between the inner blade part 9 and blade carrying structure 5 while maximizing the lift force as the flow is guided by the inner blade portions 20 and the blade carrying structure 5 adjacent to the inner blade portion 9. However, the wind turbine blade 6 can perform pivot movements, thereby increasing the pivot angle as well as increasing a distance between the inner blade part 9 and the blade carrying structure arm 5. In this scenario, the lift is not influenced by the guided flow as the inner blade part and the blade carrying structure are far apart.

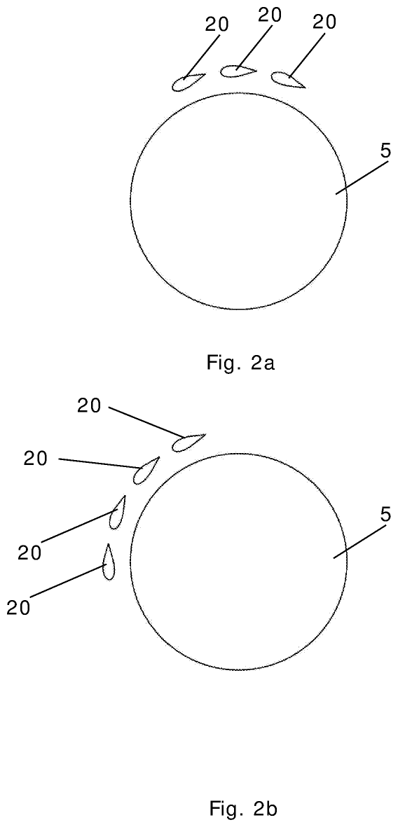

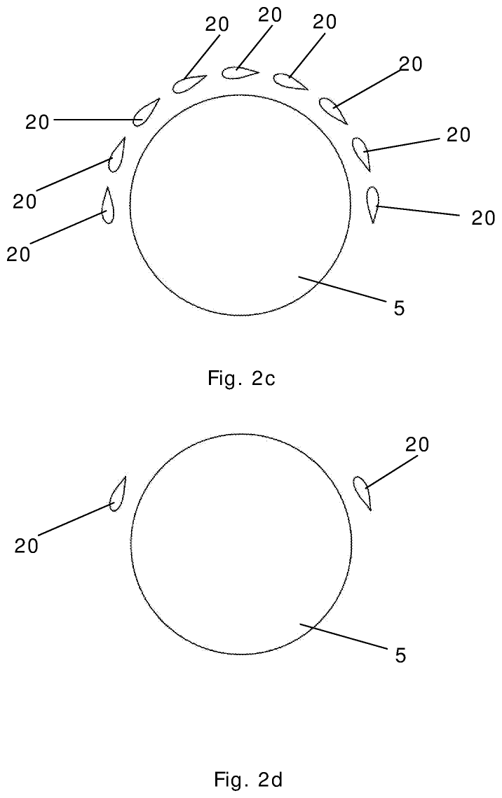

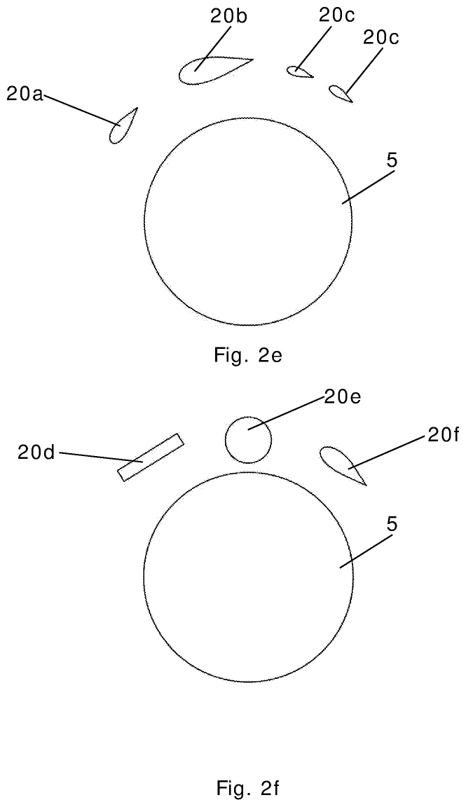

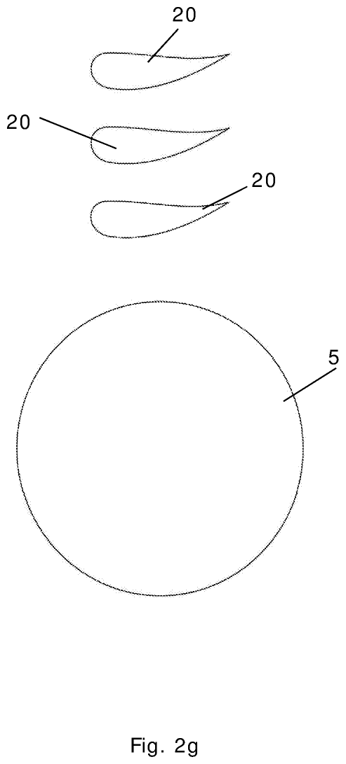

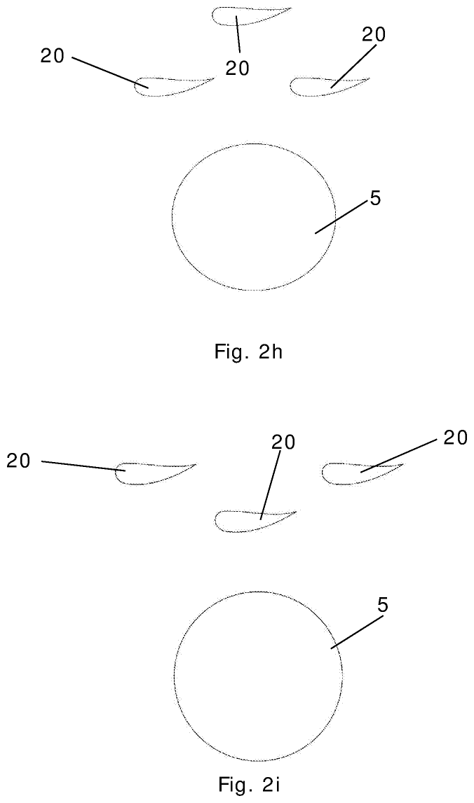

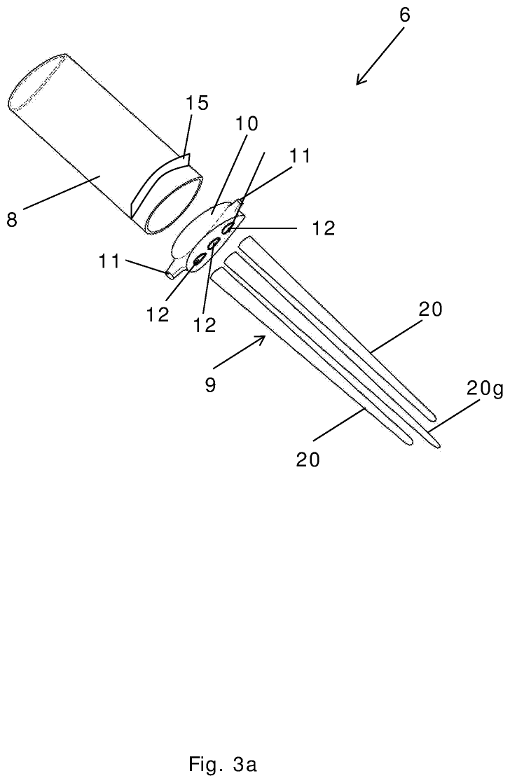

FIGS. 2a-2i show cross sectional views of a blade carrying structure arm 5 and inner blade part 9 of a wind turbine blade according to nine different embodiments of the invention.

FIG. 2a shows the blade carrying structure arm 5 having a circular cross-section and three inner blade portions 20 spaced from each other in a chord-wise direction. In the embodiment illustrated in FIG. 2a, the inner blade portions 20 are in the form of identical airfoils. The inner blade portions 20 are positioned in such a manner relative to the rotational axis of the hinge 7 that, during pivoting movements, they all move away from the blade carrying structure arm 5 in the same manner. At low wind speeds the inner blade portions 20 are in a position defining a minimum distance between the inner blade part 9 and the blade carrying structure arm 5. This is the position illustrated in FIG. 2a. When the inner blade portions 9a-9c are close to the blade carrying structure arm 5 the lift coefficient provided by the interaction between the blade carrying structure arm 5 and the inner blade portions 20 is increased, as described above. When the wind turbine blade 6 pivots the inner blade portions 20 move away from the blade carrying structure 5 along an upwards direction in the Figure, substantially synchronously.

In another embodiment shown in FIG. 2b the inner blade part 9 comprises four identical airfoils representing the inner blade portions 20. The inner blade portions of FIG. 2b are covering about a quarter of the blade carrying structure arm 5. All the inner blade portions 20 have the same orientation such that all the airfoils experience a positive angle of attack. The embodiment of FIG. 2b is beneficial as it provides for well guided flow of the wind. When the inner blade portions 20 are closest to the blade carrying structure arm 5, the lift coefficient will be increased, partly due to the proximity of the inner blade portions 20 and the blade carrying structure arm 5. The inner blade portions 20 of FIG. 2b are positioned in a manner which is different from the embodiment of FIG. 2a. During pivoting movements of the wind turbine blade, the distances between the inner blade portions 20 and the blade carrying structure arm 5 increase, and the lift coefficient will change in a different manner compared to embodiment of FIG. 2a.

FIG. 2c shows yet another embodiment of the inner blade part 9 having nine inner blade portions 20 occupying approximately half of the surface of the blade carrying structure 5 and providing even better guided flow compared to the embodiment of FIG. 2b, because the inner blade portions 20 and the blade carrying structure 5 define a large overlap.

In the embodiments shown in FIG. 2a-2c the distance between two neighbouring inner blade portions 20 is approximately the same.

FIG. 2d shows the inner blade part 9 having only two inner blade portions 20 widely separated in the chord-wise direction allowing for pivot angles greater than 90° as the blade carrying structure arm 5 can pass between the inner blade portions 20 during pivoting movements of the wind turbine blade 6.

The inner blade portions 20 may have different cross-sections and may not be placed equidistantly from each other. Such embodiments are shown in FIG. 2e-2f. FIG. 2e shows inner blade portions 20a-20c in the form of airfoils with a narrow chord. The chords of the inner blade portions 20a-20c differ from each other, i.e., the inner blade portion 20b has the largest chord length, while the two inner blade portions 20c has the shortest chord length. The chord lengths of the inner blade portions 20d-20f shown in FIG. 2f are relatively large and they have three different cross-sections. Thus, inner blade portion 20d has a cross-section in the form of a rectangle, inner blade portion 20e has a cross-section in the form of a circle, and inner blade portion 20f has an inner cross-section in the form of a droplet.

FIG. 2g shows a cross-sectional view along a cut AA indicated in FIG. 1. It shows the blade carrying structure arm 5 having a circular cross-section and three inner blade portions 20 spaced in a thickness direction. In the embodiment illustrated in FIG. 2a, the inner blade portions 20 are in the form of identical airfoils each of them having a different distance to the blade carrying structure arm 5.

FIGS. 2h and 2i show the blade carrying structure 5 with three inner blade portions 20 spaced both in the chord-wise direction and the thickness direction. The inner blade portions 20 have a different distance to blade carrying structure arm 5. In these two embodiments, the inner blade portions 20 have different cross sections and they are not placed equidistantly from each other and from the blade carrying structure 5.

All the embodiments of FIGS. 2a-2i provide an inner blade part 9 with a reduced mass compared to prior art hinged wind turbine blades as it is formed from multiple inner blade portions 20, and a large amount of material which would normally form part of the blade is therefore omitted. The lower mass of the wind turbine blade decreases the loads on the wind turbine blade itself, as well as on other parts of the wind turbine, in particular the hub, the drivetrain and the tower. This allows these parts of the wind turbine to be designed for handling lower loads, and this will result in lower mass and lower manufacturing costs for these parts, and thereby in lower total manufacturing costs for the wind turbine. A specific design of the inner blade part 9 depends on wind conditions at the site of a wind turbine and different requirements set for the power generation of the wind turbine.

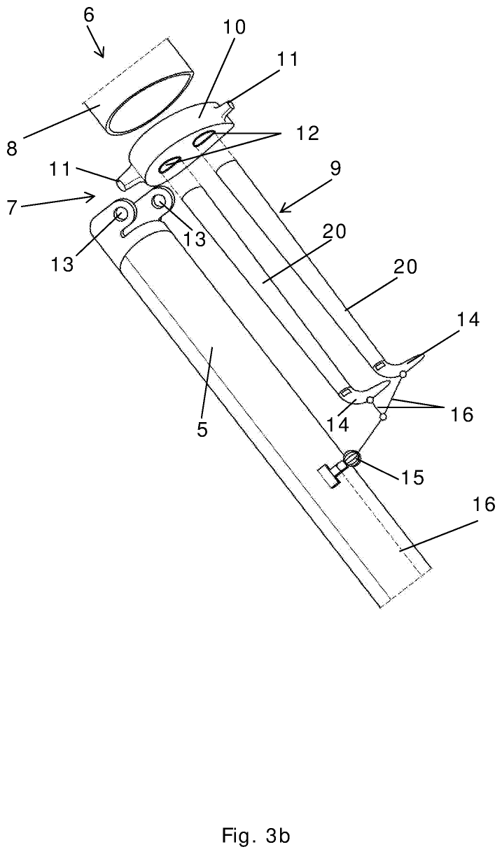

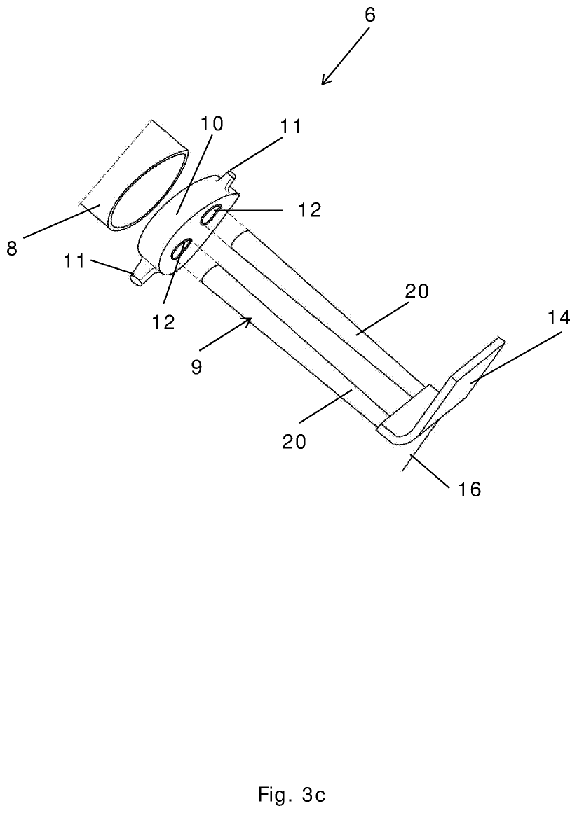

FIG. 3a is an exploded view of a part of a wind turbine blade 6 according to an embodiment of the invention. According to this embodiment, the wind turbine blade 6 is formed from an outer blade part 8 and an inner blade part 9 formed separately. The outer blade part 8 has an airfoil profile. The inner blade part 9 comprises three inner blade portions 20, spaced apart in a chord-wise direction. The inner blade portion 20g has a different length than the two other inner blade potions. The outer blade part 8 and the inner blade part 9 can be joined to each other via a hinge part 10 interconnecting the inner blade part 9 and the outer blade part 8, thereby assembling these three parts into the wind turbine blade 6. The hinge part 10 can be designed to meet requirements at the hinge, e.g. with respect to strength and material thickness, without having to consider other requirements which may be relevant for other parts of the wind turbine blade 6, e.g. with respect to weight, aerodynamic properties, flexibility, etc.

The hinge part 10 is provided with protrusions 11 which enable connection with a mating part formed on a blade carrying structure in order to form the hinge ensuring the connection of the wind turbine blade 6 with the blade carrying structure. The hinge part 10 further comprises separate mounting interfaces 12 allowing each of the inner blade portions 20 to be mounted on the hinge part 10 and thereby interconnecting it with the outer blade part 8. These separate mounting interfaces 12 are in the form of separate slots for each inner blade portion 20. One of the advantages of this embodiment is that the outer blade part 8 and the inner blade portions 20 are all manufactured separately. This is drastically simpler than manufacturing the wind turbine blade 6 in one piece as it typically requires larger moulds for moulding the blade. Furthermore, when the blade portions 8, 20 are manufactured as separate pieces, their transportation is easier and they can be assembled at a site of the wind turbine, i.e., there is no need for transporting the wind turbine blade 6 in one piece, which may require special means of transportation due to large size and large weight of the wind turbine blade. Providing the inner blade part 9 and the outer blade part 8 as two separate parts allows for assembling the wind turbine blade 6 at the site.

Also shown in FIG. 3a is a flow fence 15. The flow fence is provided in the vicinity of the hinge and is provided to prevent spanwise flow of air along the blade, in other words to reduce any flow disturbances away from the hinge. Flow fences can be provided on the suction and/or pressure sides of the outer blade part; and flow fences can be provided on the suction and/or pressure sides of the inner blade portions 20.

FIG. 3b is an exploded view of a part of a wind turbine blade 6 according to yet another embodiment of the invention. The wind turbine blade 6 is formed of the outer blade part 8 and the inner blade part 9 formed separately. The inner blade part 9 comprises two inner blade portions 20. The outer blade part 8 and the inner blade part 9 are joined to each other via a hinge part 10 interconnecting the inner blade part 9 and the outer blade part 8. The hinge part 10 forms protrusions 11 which enable a connection with the mating part 13. The hinge part 10 further comprises separate mounting interfaces 12 allowing each of the inner blade portions 20 to be mounted on the hinge part 10 and thereby interconnecting it with the outer blade part 8. Each of the inner blade portions 20 is provided with a separate winglet 14. The winglets 14 may have precisely selected mass thereby acting as balancing mass which moves a centre of mass of the wind turbine blade 6 at rest in a direction towards the inner tip portion 6a.

Each of the winglets 14 may have a wire 16 attached thereto. The wires are connected to a biasing mechanism (not shown), via a pulley. The biasing mechanism is configured to apply a biasing force to the inner blade part 9 biasing the wind turbine blade 6 towards a position defining a minimum pivot angle. The winglets 14 form a suitable position for attaching the wires 16 to the inner blade portions 20, because they are structurally strong and therefore able to withstand the forces involved when the biasing mechanism pulls the wires 16. In other examples, the wires may be connected directly to the inner blade part 9 even if a winglet is present or not.

FIG. 3c shows a part of a wind turbine blade 6 according to yet another embodiment of the invention. This embodiment is similar to one described above with reference to FIG. 3b and therefore will not be described in detail here. The only difference compared to the wind turbine blade 6 of FIG. 3b is that the inner blade portions 20 are joined to each other by a single winglet 14. As in the above described embodiment, the winglet 14 may also have a specially selected mass and may therefore act as a balancing mass defining the centre of mass of the wind turbine blade 6. The biasing mechanism (not shown) is attached to the winglet 14 via a single wire 16.

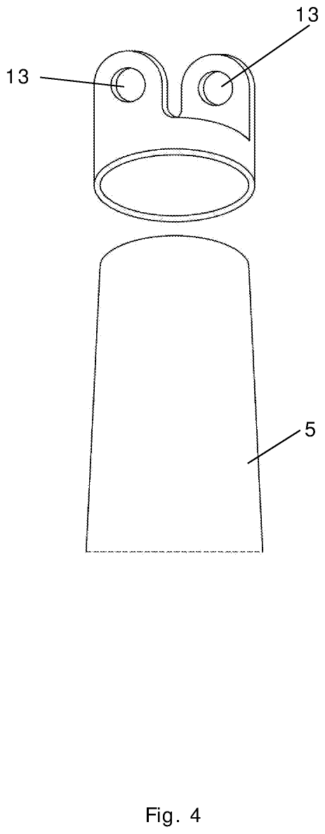

FIG. 4 shows an exploded view of a part of the blade carrying structure 5 for a wind turbine according to an embodiment of the invention. The portion of the hinge can be attached to the blade carrying structure 5 and comprises mating parts 13 which are configured to receive the protrusions (not shown) of the hinge part.

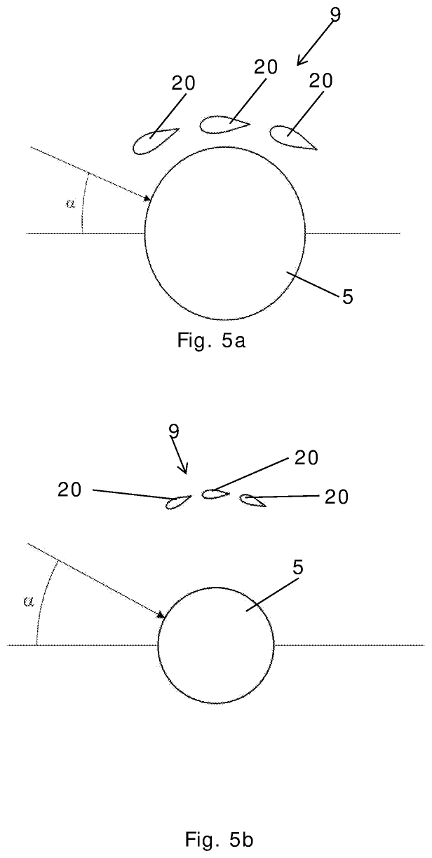

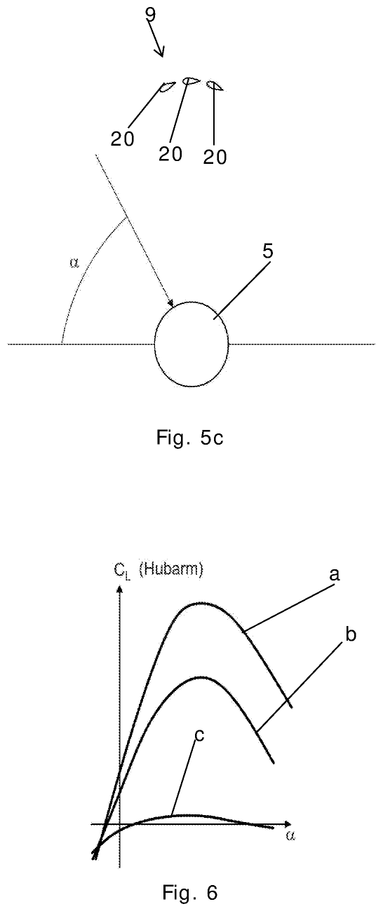

FIGS. 5a-5c show cross-sectional views of a blade carrying structure arm and inner blade part of a wind turbine blade with the wind turbine blade at three different pivot angles.

FIG. 5a illustrates the blade carrying structure arm 5 and the inner blade portions 20 arranged adjacent to each other, i.e. at a minimum pivot angle, and defining a minimum distance between each other. This distance changes as the wind turbine blade 6 performs pivot movements. Typically, the wind turbine blade 6 is in the position defining the minimum pivot angle and thereby a minimum distance between the inner blade part 9 and the blade carrying structure, as shown in FIG. 5a, at low wind speeds.

When the inner blade part 9 is close to the blade carrying structure arm 5 the lift coefficient C_{L} provided by the interaction between the blade carrying structure 5 and the inner blade portions 20 is increased. An increased lift coefficient C_{L} results in improved aerodynamic properties of the wind turbine blade 6 by the inner blade part 9 having multiple inner blade portions 20.

As the wind turbine blade pivots towards larger pivot angles the distance between the inner blade portions 20 and the blade carrying structure 5 increases as illustrated in FIGS. 5b and 5c. In FIG. 5b the pivot angle is larger than the pivot angle illustrated in FIG. 5a, and in FIG. 5c the pivot angle has increased even further. In this case, the inner blade portions 20 do not influence the aerodynamic properties to the same extent, since they are arranged further away from the blade carrying structure arm 5. The lift coefficient C_{L} provided by the interaction between the blade carrying structure 5 and the inner blade portions 20 is therefore decreased compared to the situation illustrated in FIG. 5a. This typically happens at higher wind speeds, but the pivot angle could also be increased for other reasons.

FIG. 6 is a graph showing a lift coefficient C_{L} as a function of angle of attack α relative to the blade carrying structure 5 in the three situations shown in FIGS. 5a-5c. The lift coefficient C_{L} represents a combination of the lift acting on the blade carrying structure 5 and the inner blade portions 20. Curve a corresponds to the scenario illustrated in FIG. 5a when the inner blade portions 20 are arranged adjacent to the blade carrying structure arm 5. In this scenario, the lift coefficient C_{L} is strongly dependent on the angle of attack α. Thereby, even a small change in angle of attack α will result in a large change in lift coefficient C_{L}. Accordingly, the aerodynamic properties of the combined blade carrying structure arm 5 and inner blade portions 20 is, in this case, highly sensitive to changes in angle of attack α. It can further be seen that the lift coefficient C_{L} can be relatively high for certain angles of attack α in this case.

Curves b and c correspond to situations illustrated in FIGS. 5b and 5c, respectively. It can be seen from curve b that the lift coefficient C_{L} still depends significantly on the angle of attack α. However, the variations in lift coefficient C_{L} are not as pronounced as it is the case in the situation illustrated in curve a. Furthermore, the maximum obtainable lift coefficient C_{L} is also smaller in this case. Accordingly, the impact on the aerodynamic properties is less pronounced in this case, but it is still significant.

It can be seen from curve c that the lift coefficient C_{L} in this case remains almost constant as the angle of attack α varies, and it is relatively small. Accordingly, the impact on the aerodynamic properties is more or less insignificant, because the inner blade portions 20 have been moved so far away from the blade carrying structure arm 5 that there is in reality no interaction there between.

1. A wind turbine blade having a span-wise direction between an inner tip region and an outer tip region, a chord-wise direction perpendicular to the span-wise direction and a thickness direction, the wind turbine blade comprising:
a hinge arranged to connect the wind turbine blade to a blade carrying structure of a wind turbine, the hinge being arranged at a distance from the inner tip region and at a distance from the outer tip region,
an outer blade part arranged between the hinge and the outer tip region, and
an inner blade part arranged between the hinge and the inner tip region,
wherein the inner blade part comprises at least two inner blade portions each having a profile, the inner blade portions being arranged such that the profiles are spaced from each other in the chord-wise and/or thickness direction.

2. The wind turbine blade according to claim 1, wherein the profiles of the inner blade part have a lift generating profile.

3. The A wind turbine blade according to claim 1, wherein the inner blade part and the outer blade part are two separate parts being joined to each other.

4. The wind turbine blade according to claim 3, further comprising a hinge part interconnecting the inner blade part and the outer blade part.

5. The wind turbine blade according to claim 1, wherein the inner blade part and the outer blade part form one piece.

6. The wind turbine blade according to claim 1, the wind turbine blade being configured to have a biasing mechanism attached thereto, the biasing mechanism being arranged to apply a biasing force to the wind turbine blade which biases the wind turbine blade towards a position defining a minimum pivot angle.

7. The wind turbine blade according to claim 1, wherein the inner blade portions are joined at the inner tip region.

8. The wind turbine blade according to claim 1, wherein at least one of the inner blade portions is provided with a balancing mass.

9. The wind turbine blade according to claim 1, wherein at least one of the inner blade portions is provided with a winglet.

10. The wind turbine blade according to claim 1, wherein the profiles of the inner blade portions are different from each other.

11. The wind turbine blade according to claim 1, wherein the inner blade portions have different length.

12. The wind turbine blade according to claim 1, wherein the profiles of the inner blade portions are identical.

13. The wind turbine comprising a tower, a nacelle mounted on the tower via a yaw system, a hub mounted rotatably on the nacelle, the hub comprising a blade carrying structure, and a wind turbine blade according to claim 1, the wind turbine blade being connected to the blade carrying structure via a hinge at a hinge position of the wind turbine blade, the wind turbine blade thereby being arranged to perform pivot movements relative to the blade carrying structure between a minimum pivot angle and a maximum pivot angle.

14. The wind turbine according to claim 13, wherein the blade carrying structure comprises an arm, the wind turbine blade being mounted on the arm, and wherein the arm is configured to pass between at least two of the inner blade portions of the wind turbine blade being mounted thereon during pivoting movements of the wind turbine blade.

15. The wind turbine according to claim 13, further comprising a biasing mechanism arranged to apply a biasing force to the wind turbine blade which biases the wind turbine blade towards a position defining a minimum pivot angle.

16. The wind turbine according to claim 13, wherein the inner blade portions are arranged at a distance from the blade carrying structure, and wherein the distance changes as the wind turbine blade performs pivot movements.
